(19) United States
(12) Patent Application Publication
(10) Pub. No.: US 2015/0309566 A1
(43) Pub. Date: Oct. 29, 2015

(54) GAZE TRACKING SYSTEM

(71) Applicant: Harman International Industries, Inc., Stamford, CT (US)

(72) Inventors: Vallabha Vasant HAMPIHOLI, Bangalore (IN); Srinivasa BELUR, Bangalore (IN)

(73) Assignee: Harman International Industries, Inc., Stamford, CT (US)

(21) Appl. No.: 14/264,611

(22) Filed: Apr. 29, 2014

(51) Int. Cl. G06F 3/01

(52) U.S. Cl. CPC G06F 3/013

(57) ABSTRACT

A gaze tracking system is provided with a user interface that is configured to display content and a camera that is configured to provide a signal indicative of an image of a user viewing the content. The gaze tracking system also includes a controller that communicates with the user interface and the camera. The controller is configured to determine a user interest level in the content displayed on the user interface based on movement of the user over time and to provide updated content to the user interface based on the user interest level.

### TECHNICAL FIELD

One or more embodiments relate to a motion tracking system for monitoring a user's movement and controlling content displayed on a user interface based on the movement.

### BACKGROUND

Retailers often provide specific advertising content to a consumer based on the consumer's browsing history online. However, such methods that rely on browsing history alone may make erroneous inferences. For example, if a consumer accessed a link online by accident, and then left the computer with the website open for a period of time, the website may interpret such actions as the user being interested in such content, and then the website may provide similar related content.

It is also known to monitor the position of a user's eye within its socket in order to determine the user's line of gaze, for example to determine whether the user is watching a predetermined location, such as a television screen, or simply to determine the state of wakefulness of the user. For example, U.S. Pat. No. 7,391,887 to Durnell discloses an eye tracking system that determines a user's line of gaze and a user's point of regard from the line of gaze.

### SUMMARY

In one embodiment a gaze tracking system is provided with a user interface that is configured to display content and a camera that is configured to provide a signal indicative of an image of a user viewing the content. The gaze tracking system also includes a controller that communicates with the user interface and the camera. The controller is configured to determine a user interest level in the content displayed on the user interface based on movement of the user over time and to provide updated content to the user interface based on the user interest level.

In another embodiment, a gaze tracking system is provided with a camera and a controller. The camera is configured to provide a signal indicative of an image of a user viewing content on a user interface. The controller communicates with the camera and the user interface and is configured to determine a user interest level in the content displayed on the user interface based on movement of the user over time and to provide updated content to the user interface based on the user interest level.

In yet another embodiment a method for updating content on a display is provided. Content is displayed on a user interface. Input is received that is indicative of an image of a user viewing the content. A user interest level in the content is determined based on movement of the user over time, and updated content is provided to the user interface based on the user interest level.

As such, the gaze tracking system provides advantages over existing methods for providing content to a user by updating content on a user interface based on what the individual user is presently interested in, and not solely what was displayed on the user interface in the past and viewed by the user and/or other users.

### BRIEF DESCRIPTION OF THE DRAWINGS

FIG. 1 is a front elevation view of a portable media device including a gaze tracking system according to one or more embodiments and illustrating a user interface oriented in a portrait configuration and displaying a web page;

FIG. 2 is another front elevation view of the portable media device of FIG. 1, illustrating a grid disposed over the user interface;

FIG. 3 is yet another front elevation view of the portable media device of FIG. 1, illustrating the user interface oriented in a landscape configuration;

FIG. 4 is still yet another front elevation view of the portable media device of FIG. 1, illustrating the user interface oriented in the landscape configuration and displaying the web page with updated content;

FIG. 5 is a schematic view of a media network with a plurality of devices, including the portable media device of FIG. 1, illustrated communicating with each other and with a content provider, according to one or more embodiments;

FIG. 6 is a flow chart illustrating a method for monitoring movement of a user of the portable media device of FIG. 1, according to one or more embodiments; and

FIG. 7 is a flow chart illustrating a method for updating target content displayed on the user interface of portable media device of FIG. 1 based on the movement of the user, according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In general, a gaze tracking system monitors a user's features and compares the features to predetermined data to determine if the user is recognized and if an existing profile of the user's interests is available. If the user is recognized, and their profile is available, the system provides content to the user based on their profile. If the user is not recognized, the system communicates with a content provider to receive content based on the user's characteristics (e.g., gender, age, etc.), and then provides the content to the user. The system also modifies the content provided to the user based on the user's movement, e.g., eye gaze.

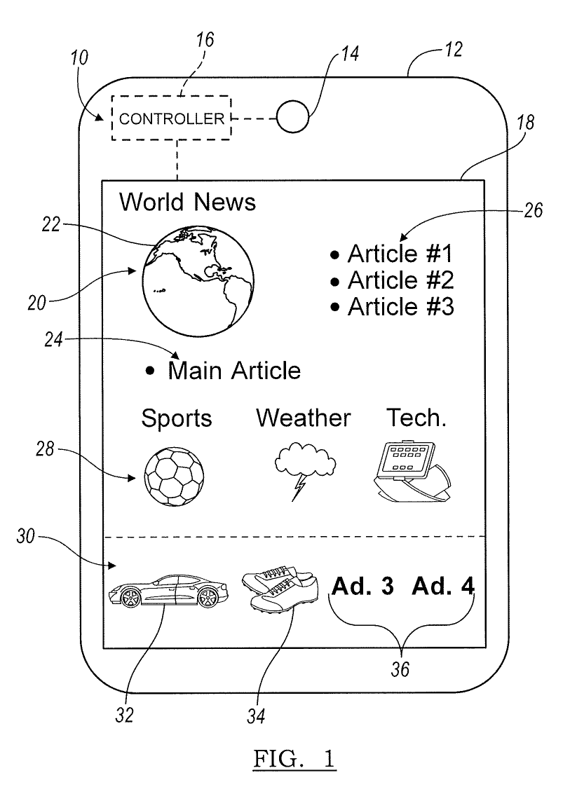

With reference to FIG. 1, a gaze tracking system is illustrated in accordance with one or more embodiments and generally represented by numeral 10. The gaze tracking system 10 is depicted within a media device 12. The media device 12 is a portable media device according to the illustrated embodiment. The gaze tracking system 10 includes a motion monitoring device 14, such as a camera, a controller 16 and a user interface 18.

The controller 16 generally includes any number of microprocessors, ASICs, ICs, memory (e.g., FLASH, ROM, RAM, EPROM and/or EEPROM) and software code to co-act with one another to perform a series of operations. The controller 16 also includes predetermined data, or “look up tables” that are based on calculations and test data and stored within the memory. The controller 16 communicates with other components of the media device 12 (e.g., the camera 14, and the user interface 18, etc.) over one or more wired or wireless connections using common bus protocols (e.g., CAN and LIN).

The media device 12 receives input that is indicative of a user command. For example, the media device 12 may include a keypad (not shown) or an input port for connecting to a peripheral keyboard so that the user may enter a command by typing. Alternatively, the user interface 18 may be configured as a touch screen for receiving tactile input from the user.

The user interface 18 displays content such as an application or a web page. In the illustrated embodiment, the user interface 18 is displaying content from a news web page. The content is displayed as both images and text. In a first region 20, world news is displayed as an image 22 and as text 24 (“Main Article”). Additional world news articles 26 (“Article #1”, “Article #2”, and “Article #3”) are also displayed as text. Other news, such as sports, weather and technology are also displayed in a second region 28 of the user interface 18 as images and text. Advertising content is displayed in a third region 30 of the user interface 18 as images and text. For example, a first advertisement 32 is for an automobile manufacturer and includes an image of a vehicle. A second advertisement 34 is for shoes and includes an image of a pair of shoes. Additional advertisements 36 include text based ads.

The gaze tracking system 10 adjusts the content displayed to the user based on the user's eye movement. The camera 14 monitors movement of the user's eyes and generates data that is indicative of the user's eye gaze. The camera 14 may adjust, e.g. pan, tilt or zoom while monitoring the user. The controller 16 analyzes this eye gaze data using known techniques to determine which region of the user interface 18 that the user is looking at. One such technique for tracking eye movement is disclosed in U.S. Pat. No. 7,391,887 to Durnell and is incorporated in its entirety by reference herein.

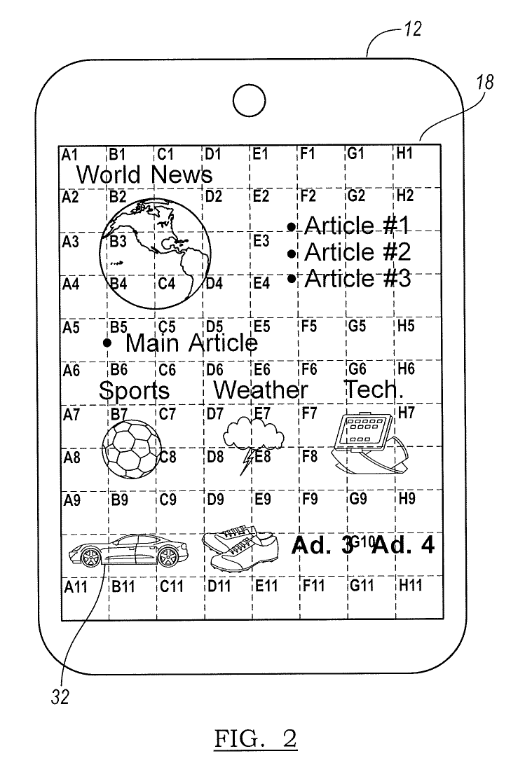

FIG. 2 illustrates the user interface 18 divided into eighty-eight generally equal sized segments to form a grid. The number of segments corresponds to the accuracy of the components and techniques used. The illustrated embodiment depicts the segments identified by a two-digit alphanumeric character, where the letter corresponds to the column and the number corresponds to the row. For example, segment H2 corresponds to the segment located in the eighth column and in the second row.

After determining which segment(s) the user is looking at, the gaze tracking system 10 determines what content is currently being displayed in the segment. For example, in one embodiment, the gaze tracking system 10 determines that the user is looking at segment A10, and that the user interface 18 is currently displaying the first advertisement 32, which is an image of the vehicle in segment A10. Therefore the gaze tracking system 10 determines that the user is interested in vehicle related content, because the user is viewing the image of the vehicle in the first advertisement 32.

The gaze tracking system 10 may also determine if the user is reading content based on the eye gaze data. For example, the gaze tracking system 10 may receive data that indicates that the user's eye gaze is slowly moving left to right from segment G10 to H10 and determine that the user is reading the text of advertisement #4.

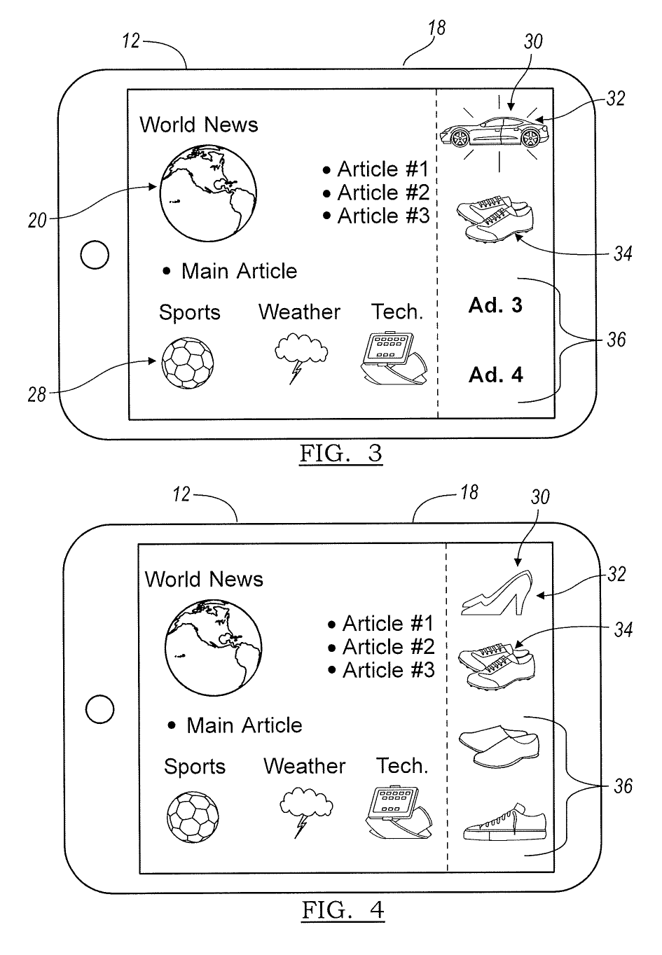

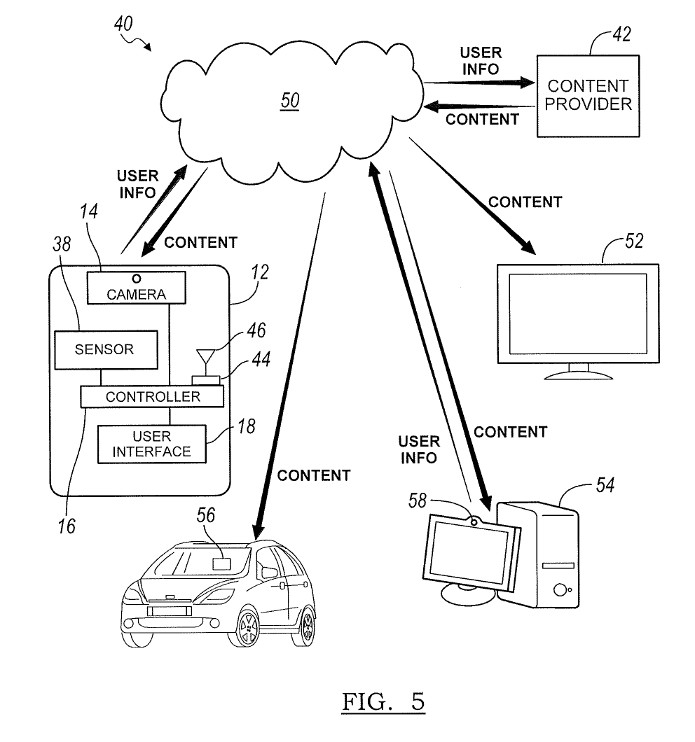

With reference to FIGS. 1-4, the media device 12 may adjust the content displayed on the user interface 18 based on the present orientation of the media device 12. In one or more embodiments, the media device 12 includes an orientation sensor 38 (shown in FIG. 5), such as a compass, gyroscope or acceleration sensor, that provides a signal that is indicative of the orientation of the media device 12. The controller 16 may automatically rotate the content displayed on the user interface 18 based on the orientation signal, when the media device 12 is rotated from a portrait configuration (shown in FIG. 1) to a landscape configuration (shown in FIG. 3). The controller 16 may also re-align and renumber the grid (shown in FIG. 2) and rearrange some of the displayed content during such changes in configuration. For example, the controller 16 may rearrange the third region 30 that includes advertising content, from a lower portion of the user interface 18 when oriented in the portrait configuration (FIG. 1) to a right side portion of the user interface 18 when orientated in the landscape configuration (FIG. 3).

In one or more embodiments, the gaze tracking system 10 may modify existing content displayed on the user interface 18 in an attempt to draw the user's attention toward the modified content. For example, the gaze tracking system 10 may control an image to blink, change color, or move, as generally depicted by the lines extending from the first advertisement 32 in FIG. 3. The gaze tracking system 10 may analyze the eye gaze data, and then modify the existing content if the eye gaze data indicates that the user has not looked at the advertising content in the third region for a certain period of time after opening the web page.

The gaze tracking system 10 may also display alternative content based on the eye gaze data. For example, if the gaze tracking system 10 determines that the user is viewing the second advertisement 34, and has not viewed the first advertisement 32 or the additional advertisements 36 based on the eye gaze data; then the gaze tracking system 10 may display alternative content for the first advertisement 32 and the additional advertisements 36.

Referring to FIGS. 3 and 4, after the gaze tracking system 10 determines that the user is viewing the second advertisement 34, which is an image of a shoe in FIG. 3, the gaze tracking system 10 adjusts the content displayed in the first advertisement 32 and the additional advertisements 36 to display other image based shoe advertisements, as shown in FIG. 4.

With reference to FIG. 5, a media network is illustrated in accordance with one or more embodiments, and is generally represented by numeral 40. The media network 40 includes the gaze tracking system 10 and a content provider 42. The gaze tracking system 10 communicates with the content provider 42 for receiving target content to display to the user. The controller 16 includes one or more transceivers 44 and at least one antenna 46 for communicating with the content provider 42. The controller provides user information (“USER_INFO”) to the content provider that is indicative of specific user information, such as gender, age, and interests. The content provider provides target content (“CONTENT”) to the controller 16 that is selected based on USER_INFO. For example, if USER_INFO indicates that the user is a male that is approximately twenty years old, the CONTENT provided by the content provider 42 may be directed to the interests that are associated with their demographic (e.g., sports, automotive or technology related). Such demographic information may be based on surveys, polls, etc.

In one or more embodiments, the gaze tracking system 10 communicates with the content provider 42 using a cloud based network 50. A profile may be established for each user of the media device 12 based on their interests as determined from past eye gazing data. This profile may be stored within the cloud network, so that cloud network 50 may provide more specific USER_INFO to the content provider 42, and in return, receive more specific CONTENT.

A plurality of other media devices may also communicate through the cloud based network 50. According to the illustrated embodiment, these other media devices include a television 52, a desktop computer 54 and a vehicle entertainment system 56. Like the portable media device 12, the desktop computer 54 includes a gaze tracking system including a camera 58 for monitoring the user, and a user interface for displaying content. However, the television 52 and vehicle entertainment system 56 include simpler versions of the gaze tracking system that each include a user interface, however they do not include a camera. Since the television 52 and vehicle entertainment system 56 do not include cameras, they are not able to monitor the user and adjust the target content displayed to the user. However, the television 52 and vehicle entertainment system 56 may be configured to allow the user to select their profile from a list of stored profiles within the cloud network 50. After selecting their profile, the cloud network 50 may communicate their USER_INFO to the content provider 42 based on their selected profile, such that specific target content is provided to their device.

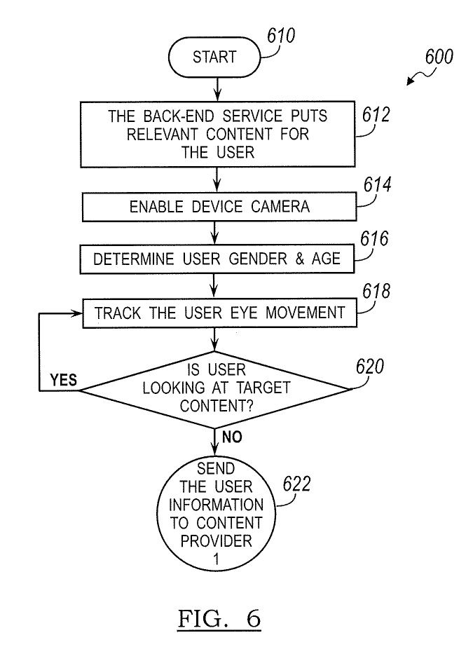

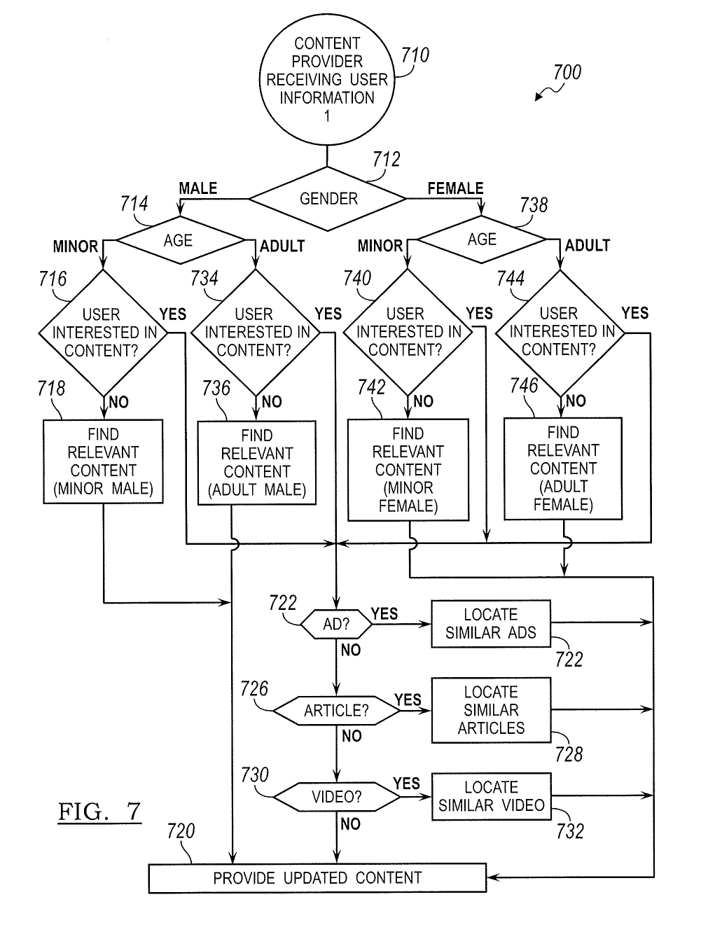

With reference to FIGS. 6 and 7 flow charts depicting a method for adjusting target content displayed on the user interface 18 is illustrated in accordance with one or more embodiments and are generally referenced by numerals 600 and 700.

Referring to FIG. 6, flow chart 600 represents the initial steps taken by the gaze tracking system. At operation 610, the gaze tracking system 10 (shown in FIG. 1) starts or initiates the method 600 once the user accesses a webpage (e.g., the news web page shown in FIGS. 1-4) that includes adjustable target content, such as the advertising content displayed in the third region 30. At operation 612, the gaze tracking system displays default target content within the third region. Such default target content may include topics of interest to a large demographic of users. Further, with reference to FIG. 1, the default target content may include image based advertisements (e.g., the first and second advertisements 32, 34) and text based advertisements (e.g., additional advertisements 36).

At operation 614, the gaze tracking system 10 enables the camera. The camera monitors the user and provides user data to the controller that is indicative of the user's external appearance. At operation 616, the controller analyzes the user data to determine the characteristics of the user, such as gender and age.

At operation 618 the controller analyzes the user data over a predetermined period of time (e.g., five to ten seconds) to track the user's eye movement or eye gaze. At operation 620, the controller determines if the user is currently viewing any of the target content. If the user is currently viewing the target content, the gaze tracking system returns to operation 618. If the user is not viewing the target content, the gaze tracking system 10 proceeds to operation 622 and provides the user information to the content provider 42 (shown in FIG. 5). The user information includes data indicative of the user's gender, age, and interests based on eye gaze data.

With reference to FIG. 7, flow chart 700 represents the steps taken by the content provider in response to the user information. At operation 710, the content provider receives the user information. At operation 712 the content provider analyzes the user information to evaluate the gender of the user. If the user is male, the content provider proceeds to operation 714 to evaluate the age of the user based on the user information. If the content provider determines that the user is a minor (e.g., less than eighteen years of age), then the content provider proceeds to operation 716 and evaluates the user's interest in the current target content from the user information, which is based on the user's eye gaze data. If the content provider determines that the user is not interested in the current target content based on the eye gaze data, then the content provider proceeds to operation 718 to find new relevant target content. The relevant target content for a minor male may include information related to sports, video games, etc. and may be displayed as images and/or text as shown in FIGS. 1-4. After operation 718 the content provider proceeds to operation 720 and provides updated target content to the gaze tracking system.

If the determination at operation 716 is positive, e.g., the user is interested in the current target content, then the content provider proceeds to operation 722 to evaluate the specific type of content that the user is viewing. At operation 722 the content provider evaluates the user information to determine if the user is viewing an advertisement. For example, the content provider may determine that the user is viewing a specific advertisement, if the eye gaze data indicates that the user's gaze is focused on a segment of the display that is currently displaying the advertisement for longer than a predetermined period of time. If the content provider determines that the user is viewing a specific advertisement, then the content provider proceeds to operation 724 and locates similar advertisement content.

If the determination at operation 722 is negative, e.g., the user is not viewing an advertisement, then the content provider proceeds to operation 726 to determine if the user is reading an article. For example, the content provider may determine that the user is reading a specific article, if the eye gaze data indicates that the user's gaze is moving horizontally along segments of the display that is currently displaying the articles. If the content provider determines that the user is reading an article, the content provider proceeds to operation 728 and locates similar article content.

If the determination at operation 726 is negative, e.g., the user is not reading an article, then the content provider proceeds to operation 730 to determine if the user is viewing a video. If the user is viewing a video, the content provider proceeds to operation 732 and locates similar video content. After operation 724, 728 or 732, the content provider proceeds to operation 720 and provides updated content to the gaze tracking system.

If the content provider determines that the user is an adult at operation 714, then the content provider proceeds to operation 734. At operation 734 the content provider evaluates the user's interest in the current target content displayed on the user interface. If the content provider determines that the user is not interested in the current target content, then the content provider proceeds to operation 736 to find new relevant target content. The relevant target content for an adult male may include content related to sports, automobiles, audio systems, investing, etc. and may be displayed as images and/or text as shown in FIGS. 1-4. After operation 736 the content provider proceeds to operation 720 and provides updated target content to the gaze tracking system. If the determination at operation 734 is positive, e.g., the user is interested in the current target content, then the content provider proceeds to operations 722-732 to find similar content, and then to operation 720 to provide the content to the gaze tracking system.

If the content provider determines that the user is female at operation 712, then the content provider proceeds to operation 738. At operation 738 the content provider evaluates the age of the user based on the user information. If the user is determined to be a minor (e.g., less than eighteen years of age), the content provider proceeds to operation 740 and evaluates the user's interest in the current target content from the user information, which is based on the user's eye gaze data. If the content provider determines that the user is not interested in the current target content, the content provider proceeds to operation 742 to find new relevant target content. If the determination at operation 728 is positive, e.g., the user is determined to be interested in the current target content, then the content provider proceeds to operations 722-732 to find similar content, and then to operation 720 to provide the new content to the gaze tracking system 10.

If the content provider 42 determines that the user is an adult at operation 726, then the content provider proceeds to operation 744. At operation 744 the content provider 42 evaluates the user's interest in the current target content displayed on the user interface 18. If the content provider determines that the user is not interested in the current target content, the content provider proceeds to operation 746 to find new relevant target content. If the determination at operation 744 is positive, then the content provider 42 proceeds to operations 722-732 to find similar content, and then to operation 720 to provide the new content to the gaze tracking system 10.

In one or more embodiments, the gaze tracking system may modify a user's profile based on their online shopping history, so that the content may be updated based on their budget and/or lifestyle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A gaze tracking system comprising:
a user interface configured to display content;
a camera configured to provide a signal indicative of an image of a user viewing the content; and
a controller communicating with the user interface and the camera and configured to determine a user interest level in the content displayed on the user interface based on an eye gaze of the user over time and to provide updated content to the user interface based on the user interest level.

2. The gaze tracking system of claim 1 wherein the controller is further configured to:
determine a segment on the user interface that the user is currently viewing based on the eye gaze; and
determine the user interest level in the content displayed on the segment in response to a time duration of the eye gaze on the segment.

3. The gaze tracking system of claim 2 wherein the controller is further configured to provide the updated content to non-viewed segments on the user interface in response to the user interest level.

4. The gaze tracking system of claim 2 wherein the controller is further configured to provide the updated content to non-viewed segments on the user interface that correspond to the content displayed on the segment in response to the time duration of the eye gaze on the segment exceeding a predetermined period of time.

5. The gaze tracking system of claim 1 wherein the content and the updated content includes at least one of an image, text and a video.

6. The gaze tracking system of claim 1 wherein the controller is further configured to determine demographic information of the user including at least one of a gender and an age based on the signal.

7. The gaze tracking system of claim 6 wherein the controller is further configured to compare the demographic information to predetermined profile data to select a profile associated with the user and to provide the updated content to the user interface based on the user interest level and the profile.

8. The gaze tracking system of claim 7 wherein the controller is further configured to modify the profile associated with the user based on the user interest level.

9. The gaze tracking system of claim 6 wherein the controller is further configured to provide user information indicative of the demographic information and the user interest level to a content provider, and to receive the updated content from the content provider.

10. The gaze tracking system of claim 9 wherein the content provider is configured to provide the updated content that corresponds to the content in response to the user interest level indicating that the user is interested in the content.

11. The gaze tracking system of claim 9 wherein the content provider is configured to provide the updated content based on the demographic information in response to the user interest level indicating that the user is not interested in the content.

12. A media network comprising:
a first media device including the gaze tracking system of claim 1;
a second media device including a second user interface configured to display content, an input device for selecting a profile and a second controller in communication with the second user interface and the input device; and
a content provider in communication with the controller and the second controller and configured to provide the updated content in response to at least one of the user interest level and the profile.

13. A computer-program product embodied in a non-transitory computer readable medium that is programmed for tracking an eye gaze of a user, the computer-program product comprising instructions for:
receiving a signal indicative of an image of a user viewing content on a user interface;
determining a user interest level in the content displayed on the user interface based on an eye gaze of the user over time; and
providing updated content to the user interface based on the user interest level.

14. The computer-program product of claim 13 further comprising instructions for:
determining a segment on the user interface that the user is currently viewing based on the eye gaze; and
determining the user interest level in the content displayed on the segment in response to a time duration of the eye gaze on the segment.

15. The computer-program product of claim 14 further comprising instructions for providing the updated content to non-viewed segments on the user interface in response to the user interest level.

16. The computer-program product of claim 14 further comprising instructions for providing the updated content to non-viewed segments on the user interface that correspond to the content displayed on the segment in response to the time duration of the eye gaze on the segment exceeding a predetermined period of time.

17. A method for updating content on a display comprising:
displaying content on a user interface;
receiving an input indicative of an image of a user viewing the content;
determining a user interest level in the content based on an eye gaze of the user over time; and
providing updated content to the user interface based on the user interest level.

18. The method of claim 17 further comprising:
determining a segment on the user interface that the user is currently viewing based on the eye gaze; and
determining the user interest level in the content displayed on the segment in response to a time duration of the eye gaze on the segment.

19. The method of claim 18 further comprising providing the updated content to non-viewed segments on the user interface in response to the user interest level.

20. The method of claim 18 further comprising providing the updated content to non-viewed segments on the user interface that correspond to the content displayed on the segment in response to the time duration of the eye gaze exceeding a predetermined period of time.
